(19) United States
(12) Patent Application Publication
(10) Pub. No.: US 2006/0056421 A1
(43) Pub. Date: Mar. 16, 2006

(54) Reducing latency when transmitting acknowledgements in mesh networks

(75) Inventor: Maged Zaki, Pierrefonds (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/010,465

(22) Filed: Dec. 13, 2004

Related U.S. Application Data
(60) Provisional application No. 60/608,775, filed on Sep. 10, 2004.

(51) Int. Cl. H04L 12/56; H04L 12/28; H04B 7/212

(52) U.S. Cl. 370/400; 370/428; 714/746

(57) ABSTRACT

A method for reducing latency in transmitting an acknowledgement (ACK) in a mesh network begins by receiving a data packet at an intermediate node from a source node. The intermediate node generates an ACK upon receipt of the data packet. The intermediate node then forwards the data packet to a target node, including the ACK in the forwarded data packet. By combining the ACK with the data packet, the source node receives the ACK while the target node receives the data packet.

### CROSS REFERENCE TO RELATED APPLICATION

This application claims the benefit of U.S. Provisional Application No. 60/608,775, filed Sep. 10, 2004, which is incorporated by reference as if fully set forth herein.

### FIELD OF INVENTION

The present invention relates generally to wireless local area networks (WLANs) and, more particularly, to a method for reducing latency in transmitting acknowledgements (ACKs) in a mesh network.

### BACKGROUND

In an 802.11 wireless local area network (WLAN) setting, one type of network that can be created is a mesh network, which involves several stations (STAs) or nodes communicating directly with each other, rather than through an access point (AP). Two problems in WLANs are especially prevalent in mesh networks: hidden node and exposed node.

FIGS. 1a and 1b show a general overview of the hidden node problem. The hidden node problem results from the scenario in which, as shown in FIG. 1a, node A is within range of node B and node C is within range of node B, but node A is not within range of node C. In this setting, node A and node C are “hidden” from each other. If both node A and node C attempt to send information to node B at the same time, there will be a collision at node B, as shown in FIG. 1b.

The use of the request-to-send (RTS)/clear-to-send (CTS) virtual carrier-sense mechanism can prevent some of the hidden node problems, but not all. A node that wants to transmit (a source node) sends an RTS frame to the intended recipient node (a destination or target node). The RTS frame can also by heard be all nodes within the range of the source node. The destination node replies to the RTS frame by sending a CTS frame to the source node. As with the RTS frame, the CTS frame can be heard by all nodes within range of the destination node.

The RTS/CTS mechanism can cause additional problems when used in a mesh network. FIG. 2 shows a mesh network with four nodes (A, B, C, and D), where node A is a source node, node B is a destination node, node C is a hidden destination node, and node D is a source node. In the example shown in FIG. 2, node A sends an RTS frame. Because node C is hidden from node A, it does not hear the RTS from node A. Node B receives the RTS frame and replies with a CTS frame.

At the same time node B transmits its CTS frame, node D sends an RTS frame. Both the CTS frame from node B and the RTS frame from node D are received at node C at the same time, causing a collision at node C. This collision prevents node C from responding to node D's RTS frame, requiring node D to retransmit the RTS frame. At the same time of the collision at node C, node A receives the CTS frame from node B and prepares to begin its data transmission.

While node A is beginning its data transmission, node C receives the second RTS frame from node D. Node C replies to the second RTS from node D, and the CTS frame from node C is also heard by node B. At the same time, the data transmission arrives from node A, causing a collision at node B. This example illustrates that overhearing a CTS (at node C) from neighboring nodes (node B) over the same channel can inhibit a remote node (node D) from transmitting to its neighboring nodes (node C).

The exposed node problem results from a scenario like that shown in FIG. 3, where a node that overhears communications intended for another node is prevented from transmitting to a remote node. For example, node B sends a CTS, which is received by both node A and node C. When node C receives the CTS, it enters a backoff period, thereby preventing it from sending its own RTS. Due to the unintentional backoff in the mesh configuration, this behavior has a large impact on the overall system performance. The exposed node problem can prevent independent parallel communication among other mesh points over the same channel.

Each node has a network allocation vector (NAV) table which contains the remaining time of packet transmission of the neighboring nodes. Nodes conduct virtual carrier-sense detection and when the channel is physically sensed to be idle and the NAV table is empty, the source node sends an RTS packet. All other idle nodes, upon hearing an RTS, update their NAV table and defer their own transmissions (i.e., enter a backoff period). The destination node sends a CTS packet to respond to the RTS packet. Nodes neighboring the destination node overhear the CTS and update their NAV tables. After receiving the CTS, the source node transmits data and receives an acknowledgement (ACK).

In a WLAN, each frame has to be acknowledged by the receiving side. For example, as shown in FIG. 4, when node B receives a data frame from node A, node B has to send an ACK for this data packet and then start forwarding the data packet to node C. Performing the ACKs at each node increases both the traffic load and the latency in an 802.11 mesh network.

The hidden node and exposed node problems are conflicting issues, and are especially relevant in an auto-configured mesh deployment. RTS/CTS virtual carrier-sensing is not sufficient to completely resolve those problems for the mesh architecture. In addition, the enabling of broadcast and multicast traffic within the mesh network can intensify the hidden node and exposed node interference problems, thereby degrading the overall system throughput. Therefore, a method and apparatus are needed for reducing latency when transmitting ACKs in mesh networks.

### SUMMARY

A method for reducing latency in transmitting an acknowledgement (ACK) in a mesh network begins by receiving a data packet at an intermediate node from a source node. The intermediate node generates an ACK upon receipt of the data packet. The intermediate node then forwards the data packet to a target node, including the ACK in the forwarded data packet. By combining the ACK with the data packet, the source node receives the ACK while the target node receives the data packet.

A system for reducing latency in transmitting an acknowledgement (ACK) in a mesh network having a source node, an intermediate node, and a target node includes a data packet and an ACK. The data packet is sent by the source node to the intermediate node. The ACK is generated by the intermediate node upon receipt of the data packet from the source node. The intermediate node then forwards the data packet with the ACK to the target node. By combining the ACK with the data packet, the source node receives the ACK while the target node receives the data packet.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIGS. 1a and 1b are diagrams of an overview of the hidden node problem in a WLAN;

FIG. 2 is a diagram showing an example of a collision problem caused by the hidden node problem;

FIG. 3 is a diagram of the exposed node problem in a WLAN;

FIG. 4 is a diagram showing a prior art WLAN acknowledgement mechanism;

FIG. 5 is a diagram showing a piggybacked acknowledgement mechanism in accordance with the present invention;

FIG. 6 is a diagram of an existing 802.11 data frame format;

FIG. 7 is a diagram of a data frame format in accordance with one embodiment of the present invention;

FIG. 8 is a diagram of a data frame format in accordance with another embodiment of the present invention; and

FIG. 9 is a diagram of a negative acknowledgement frame format in accordance with the present invention.

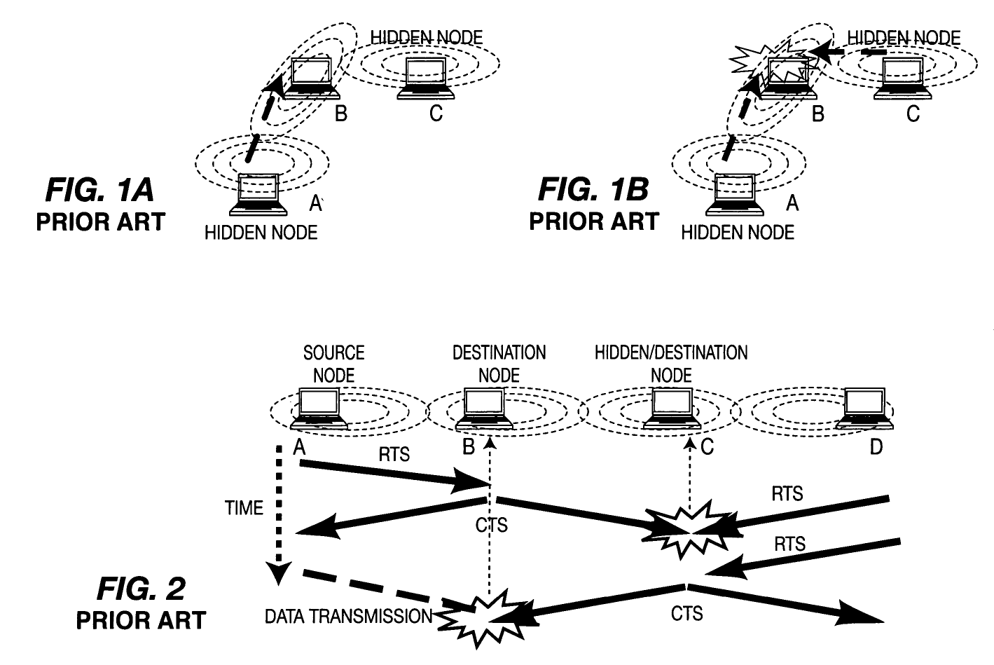

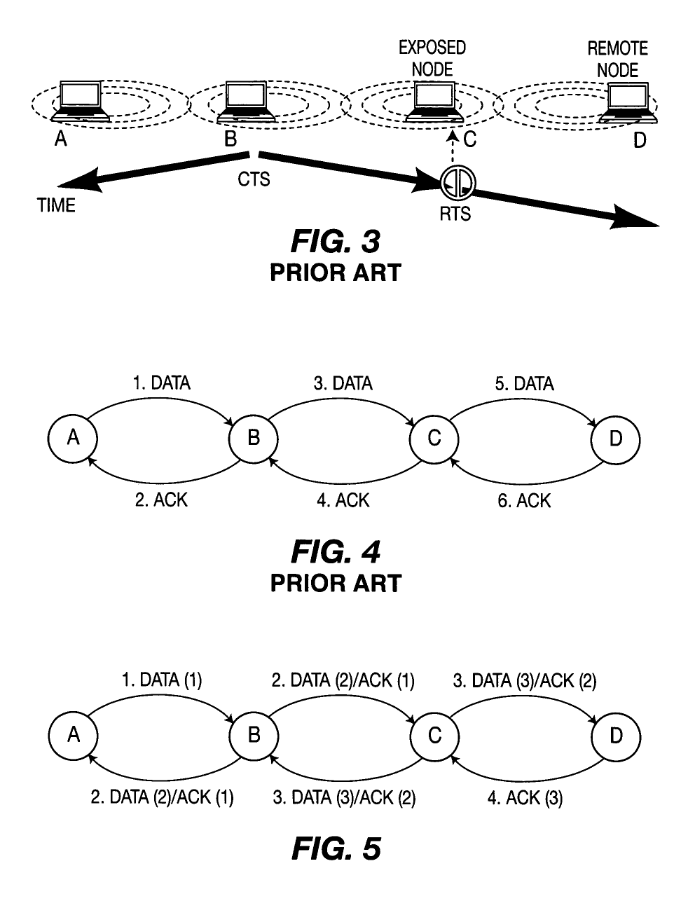

### DETAILED DESCRIPTION OF THE PREFERRED EMBODIMENTS

Hereafter, a node includes, but is not limited to, a wireless transmit/receive unit (WTRU), a user equipment, a mobile station, a fixed or mobile subscriber unit, a pager, or any other type of device capable of operating in a wireless environment. When referred to hereafter, an access point includes, but is not limited to, a base station, a Node B, a site controller, or any other type of interfacing device in a wireless environment.

To avoid increasing system load and latency, the present invention provides for piggybacking acknowledgements (ACKs) on data packets. When a node receives a data packet, it updates the address field in the data packet and piggybacks the ACK of the received packet onto the forwarded data packet. Since the carrier sense multiple access with collision avoidance (CSMA/CA) medium access protocol allows all the near nodes to hear this transmission (by exploiting the exposed node problem), the previous and next nodes in the communication path will be able to hear the transmission. The previous node receives the ACK and the next node receives the forwarded data packet.

By transmitting only a single packet, instead of separate ACK and data packets, the system latency is improved and the system load is decreased. Utilizing this mechanism requires changing the 802.11 MAC frame format, to properly address the data packet and the ACK packet. It is noted that the source node, as referred to herein, is the node that is transmitting at the time in question, and not necessarily the node the originated the transmission.

FIG. 5 shows a diagram of an ACK mechanism for mesh networks in accordance with the present invention. In this example, node A sends a data frame (Data (1)) to node B. When node B receives the data frame, it forwards the data frame (Data (2)) to node C as follows:

1) Piggyback the ACK to node A (ACK(1)) on the data frame; and

2) Forward the data frame with the piggybacked ACK (Data (2)/ACK(1)) to node C.

Since node A also hears node B's transmission to node C, it knows that the packet was received successfully and that the ACK timer will not expire. A similar transmission occurs when node C forwards the data packet to node D. By way of example, three embodiments of this ACK mechanism may be employed as explained below.

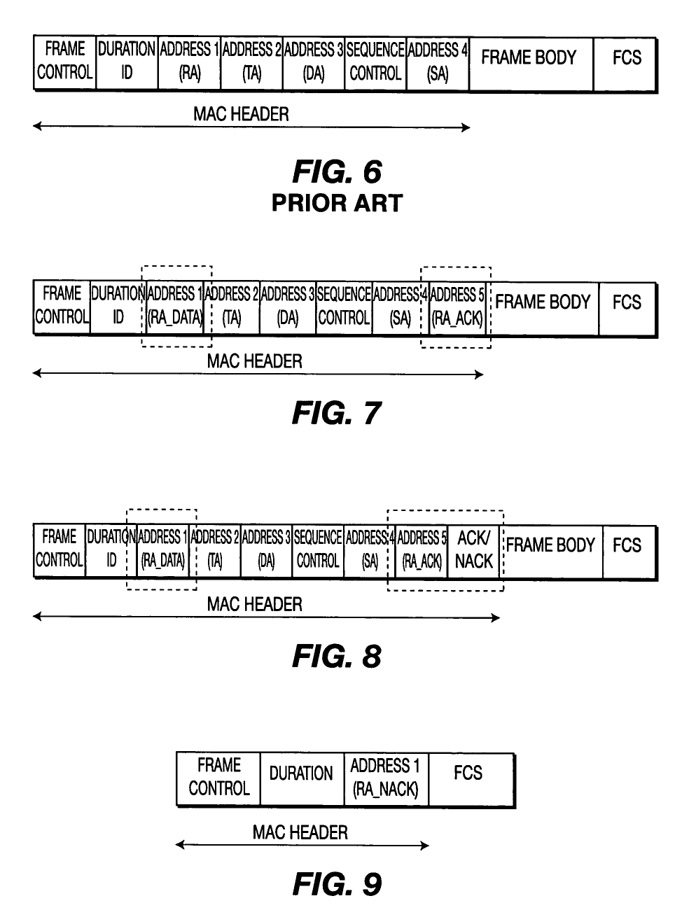

FIG. 6 shows a typical frame format under current 802.11 standards. The first embodiment of the ACK mechanism is a positive ACK mechanism; a data frame format in accordance with this embodiment is shown in FIG. 7. When the destination node receives the data packet correctly, it piggybacks the ACK to the data packet indicating that the data packet was received properly.

This embodiment adds a field, Address 5, to indicate the ACK recipient's address (i.e., the source node). As shown in FIG. 7, Address 1 indicates the data frame recipient's address (RA_data) and Address 5 indicates the ACK frame recipient's address (RA_ACK). As applied to the example shown in FIG. 5, Address 1 would have the address of node C and Address 5 would have the address of node A.

The second embodiment of the ACK mechanism is an ACK/NACK mechanism. Similar to the first embodiment, when the destination node receives the data packet, it piggybacks the ACK to the data packet indicating that the data packet was received. Referring to FIG. 8, Address 1 indicates the data frame recipient's address (RA_data) and the new field Address 5 indicates the ACK frame recipient's address (RA_ACK), as explained above.

A second new field, called the ACK/NACK field, is a Boolean field. If it is set to zero, this means that the recipient did not receive the packet properly, and the recipient has the choice to either ACK or NACK the packet. The ACK/NACK field allows the destination node to send an ACK frame when it receives the packet from the sender properly, by setting the field to one. If the recipient node does not receive the packet (i.e., when a packet is received with an incorrect sequence number, the recipient knows that it missed the packet) or if the recipient node could not decode the received packet properly, it can send a NACK to the sender by setting the field to zero.

As applied to the example shown in FIG. 5, the ACK/NACK field would be set to zero if node B did not correctly receive the Data(1) packet from node A. When node B sends the Data(2)/ACK(1) packet, node C receives the data packet, and node A is informed that the packet was incorrectly received by node B. Whether node B sends the Data(2) packet to node C depends on what caused the incorrect receipt at node B. If the current packet was not received properly, node B will not send a Data(2) packet to node C and will send a NACK to node A. However, if node B received the packet properly, but with a sequence number other than what it was expecting, node B can still forward the Data(2) packet to node C and send a NACK to node A for the missed packet. For example, if node B receives a packet with a sequence number of “n+1” instead of “n”, then node B can forward the “n+1” packet to node C and send a NACK to node A for the “n” packet.

The third embodiment of the ACK mechanism is a negative acknowledgement (NACK) mechanism. In this embodiment, when the destination node does not receive a data packet, it sends a NACK to the source node to indicate that the data packet was missing. The destination node knows that it missed a packet when a packet is received with an incorrect sequence number or if a packet is received that it cannot decode correctly. The source node assumes that the data packet was received properly if it did not receive a NACK within a specific period of time. FIG. 9 shows an example of a NACK frame in accordance with this embodiment. It is noted that the NACK frame format is the same as the standard 802.11 ACK frame format.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for reducing latency in transmitting an acknowledgement (ACK) in a mesh network, comprising the steps of:
receiving a data packet at an intermediate node from a source node;
generating an ACK upon receipt of the data packet at the intermediate node; and
forwarding the data packet from the intermediate node to a target node including the ACK in the forwarded data packet, whereby the source node receives the ACK while the target node receives the data packet.

2. The method according to claim 1, wherein the data packet includes the address of the source node to receive the ACK.

3. The method according to claim 1, wherein the data packet includes a field to indicate whether the packet was received at the intermediate node.

4. The method according to claim 1, wherein the data packet includes:
the address of the source node to receive the ACK; and
a field to indicate whether the packet was received at the intermediate node.

5. A system for reducing latency in transmitting an acknowledgement (ACK) in a mesh network having a source node, an intermediate node, and a target node, the system comprising:
a data packet sent by the source node to the intermediate node; and
an ACK generated by the intermediate node upon receipt of said data packet from the source node, the intermediate node forwarding said data packet with said ACK to the target node, whereby the source node receives said ACK while the target node receives said data packet.

6. The system according to claim 5, wherein said data packet includes an address of the source node, the address being inserted into said data packet by the intermediate node prior to transmitting said data packet to the target node, such that said ACK is properly addressed to the source node.

7. The system according to claim 5, wherein said data packet includes a field to indicate whether said packet was received at the intermediate node.

8. The system according to claim 5, wherein said data packet includes:
an address of the source node, the address being inserted into said data packet by the intermediate node prior to transmitting said data packet to the target node, such that said ACK is properly addressed to the source node; and
a field to indicate whether said packet was received at the intermediate node.
